(19) United States
(12) Patent Application Publication
(10) Pub. No.: US 2007/0186824 A1
(43) Pub. Date: Aug. 16, 2007

(54) Heat-generating cement body, heat-generating cement tile and manufacturing method thereof

(75) Inventors: Hitomi Takahashi, Miyagi (JP); Teitaro Takahashi, Miyagi (JP); Tetsuo Adachi, Hyogo (JP); Hiroshi Kameyama, Miyagi (JP)

Correspondence Address: CROWELL & MORING LLP;INTELLECTUAL PROPERTY GROUP, P.O. BOX 14300, WASHINGTON, DC, 20044-4300, US

(73) Assignee: HITOMI TAKAHASHI, MIYAGI (JP)

(21) Appl. No.: 10/584,127

(22) PCT Filed: Dec. 24, 2004
(86) PCT No.: PCT/JP04/19439

§ 371 Date: Jun. 23, 2006

(30) Foreign Application Priority Data
Dec. 26, 2003 (JP) 2003-433365
Dec. 17, 2004 (JP) 2004-365911

(51) Int. Cl. C04B 14/00; B28B 3/00; C04B 24/00

(52) U.S. Cl. 106/814; 106/717; 264/333

(57) ABSTRACT

A sidewalk tile with snow-removal function is stably obtained that is capable of being heated to a desired temperature, while at the same time sufficiently maintaining strength. A heat-generating concrete body is obtained by mixing particle-form (granular) or powder-form carbon material with un-hardened concrete at a specified ratio, and then pressing it with a high-pressure press at a pressure of approximately 980 kN to remove moisture and to form it into a tile shape. A pair of electrodes are embedded in end sections on both ends in the width direction of the heat-generating concrete body. The outer surfaces of the heat-generating concrete body are covered with an insulation-coating layer. One side and the circumference of the heat-generating concrete body are covered with un-hardened concrete and formed into a single tile shape by pressing with a high-pressure press to obtain a sidewalk tile with the snow-removal function.

### BACKGROUND OF THE INVENTION

1. Field of the Invention

The heat-generating cement body and heat-generating cement tile of this invention are used for a sidewalk tile having a snow-removal function for snowy regions where there is heavy snowfall, and is used for removing accumulated snow and preventing the top from freezing.

2. Description of the Related Art

In snowy regions where there is heavy snowfall, when lots of snow accumulates on the sidewalk it becomes a nuisance and hindrance for people walking on the sidewalk. Also, when the top of the sidewalk freezes, there is danger that pedestrians could slip and fall. Therefore, in the past, methods for removing (melting) the accumulated snow from the sidewalk, such as spraying water onto the sidewalk from the side of the sidewalk, or burying an electric-heating cable underneath the sidewalk and removing the snow using the heat that is transferred to the top of the sidewalk (road surface) by running current through the cable to heat it, have been performed.

However, in the case of spraying water onto the sidewalk, troublesome work of installing piping is necessary. Also, since water is continuously sprayed, it causes the running cost to increase. On the other hand, in the case of using an electric-heating cable, these kinds of problems are few, however, it is difficult to effectively melt (remove) the snow that is accumulated on top of the sidewalk. In other words, when using the aforementioned electric-heating cable to remove snow by using just the heat transferred to the top surface of the sidewalk, only the snow that is in contact with the top surface of the sidewalk melts (the snow melts into a tunnel shape), so it is not possible to effectively melt the snow on top.

Taking these problems into consideration, the inventors considered mixing carbon material (carbon powder) such as powder graphite into a concrete sidewalk tile, and heating the sidewalk tile by running electric current through the inside of the sidewalk tile. However, by simply mixing carbon powder into the un-hardened (fresh) concrete material and hardening the concrete by a hydration reaction, moisture and air are mixed in and exist in the concrete, so bonding (contact) between the carbon powder particles is easily inhibited. Also, with this kind of construction, it is difficult to uniformly mix (distribute) the carbon powder into the aforementioned material. Some reasons why it is difficult to uniformly mix in the carbon powder in this way are surface tension or the properties of powder (minute powder particles) in the liquid. Therefore, it is difficult to make the concrete sidewalk tile such that it has a desired electrical-resistance value, and there is still much room for improvement in order to stably obtain sufficiently large sidewalk tiles having a snow-removal function capable of heating.

Moreover, in order to obtain the desired low electrical-resistance value on the inside of this kind of construction, it is necessary to increase the ratio of carbon powder that is contained in the un-hardened concrete. However, when this ratio is increased, it was found that the strength of the sidewalk tile is insufficient.

As reference documents of the prior art related to this invention are patent documents 1 to 3.
[Patent Document 1]

Japanese Patent No. 2001-123408
[Patent Document 2]

Japanese Patent No. 2003-64617
[Patent Document 3]

Japanese Patent No. 2003-193413

### SUMMARY OF THE INVENTION

Taking the aforementioned problems into consideration, the object of this invention is to solve all of the problems that occurred with the prior construction as described above.

Of the heat-generating cement body and heat-generating cement tile of this invention, the heat-generating cement body is formed by mixing particle-form or powder-form carbon material in un-hardened concrete or mortar at a specified ratio, and then pressing it with a high-pressure press to remove moisture and form it into a specified shape such that electric current is capable of freely passing through the inside by way of electrodes that are located on both sides.

It is preferred that the heat-generating cement tile be formed by pressing un-hardened concrete or mortar that has been placed on at least one side of said heat-generating cement body with a high-pressure press to integrate the heat-generating cement body with the concrete or mortar and form it into a tile shape.

Also, it is preferred that the heat-generating cement tile be formed by embedding the heat-generating cement body described above inside the concrete or mortar.

The heat-generating cement body of this invention is made by arranging a pair of electrodes inside a form in the sections near both ends such that they are parallel with each other, mixing particle-form or powder-form carbon material into un-hardened concrete or mortar at a specified ratio and then mixing it with water and pouring it into the form, then pressing it with a high-pressure press to remove moisture.

The heat-generating cement tile of this invention is made by first, arranging a pair of electrodes inside a form in the sections near both ends such that they are parallel with each other, then mixing particle-form or powder-form carbon material with un-hardened concrete or mortar at a specified ratio, mixing with water and pouring it inside the form, then pressing the poured concrete or mortar with a high-pressure press to remove the moisture and form a heat-generating cement body. Next, with electric wires connected to both ends of the electrodes in the heat-generating cement body, the heat-generating cement body is placed inside a concave section that is formed on the top surface of a concrete or mortar tile-shaped member such that there is space between the underneath surface and surfaces around the circumference of the heat-generating cement body and the bottom surface and inner surfaces of the concave section, and such that the top surface of the heat-generating cement body is dropped further downward than the edge sections around the opening of the concave section on the top surface of the tile-shaped member, then melted insulating resin or plastic is poured into the concave section and this insulating resin or plastic is let to harden. After that, un-hardened concrete or mortar is poured on the top side of the heat-generating cement body inside the concave section and let to harden so that this concrete or mortar is integrated with the tile-shaped member and heat-generating cement body.

### EFFECT OF THE INVENTION

The heat-generating cement body and heat-generating cement tile that are obtained from the method of manufacturing the heat-generating cement body and heat-generating cement tile of this invention described above are constructed such that carbon material is contained in un-hardened concrete or mortar and pressed by a high-pressure press to remove moisture and form a desired shape. Therefore, it is possible to sufficiently press the moisture and air from the un-hardened concrete or mortar, and to improve the distribution density of the carbon material. Also, it is possible to uniformly mix the carbon material inside the heat-generating cement body. Therefore, contact among the carbon material is not hindered, and it is possible to more easily and effectively have contact among some carbon material. Moreover, by adjusting the ratio of the amount of carbon material contained in heat-generating cement body, it is possible to more effectively have contact among particle-form or powder-form carbon material, and to adjust the electrical resistance inside the heat-generating cement body to a specified value. As a result, by passing current through the inside of the heat-generating cement body by way of electrodes that are located on both sides of the heat-generating cement body, it is possible to heat the heat-generating cement body and heat-generating cement tile to a desired temperature. Furthermore, in the case of this invention, this kind of construction is stably obtained. Also, since it is possible to uniformly mix the carbon material inside the heat-generating cement body, it becomes possible to uniformly heat the heat-generating cement body, so the energy efficiency is good. Moreover, it is possible to improve strength, while at the same time maintain good conductivity inside.

To explain this in more detail, conventionally when mixing and dispersing carbon material in cement, due to the surface tension of the carbon material, it was difficult to uniformly disperse the carbon material in un-hardened concrete or mortar with just normal mixing. For example, when dispersing carbon material in a polymer, by adding a dispersing agent (interface active material) or the like, uniform dispersion becomes possible. However, in the case of obtaining the heat-generating cement body of this invention, it is not possible to use this kind of dispersing agent to uniformly disperse the carbon material, so it is difficult to uniformly disperse the carbon material in un-hardened concrete or mortar by only normal mixing. Also, as a heat-generating element, in order to obtain the necessary internal conductivity, it is necessary that the particles of carbon material are continuous and come in contact with each other inside the heat-generating element. Therefore, it is feasible that as a means to accomplish this, the ratio (content) of the amount of carbon material contained in the un-hardened concrete or mortar be increased. However, increasing the amount of carbon material contained may become a cause for inviting insufficient strength of this heat-generating element made of concrete or mortar.

On the other hand, in the case of the heat-generating cement body of this invention, particle-form or powder-form carbon material is contained in the un-hardened concrete or mortar, and it is pressed by a high-pressure press to remove moisture. Therefore, when applying pressure and removing moisture, due to the osmotic pressure (drainage osmotic pressure) that occurs when discharging moisture from the un-hardened concrete or mortar, it becomes easy for uniform dispersion phenomenon of the carbon material to occur. As a result, it is feasible that it will become easy to uniformly distribute the carbon material inside the heat-generating cement body. Also, by becoming easy to uniformly distribute carbon material inside the heat-generating cement body, it is possible to keep the amount of carbon material contained needed for obtaining good conductivity sufficiently low. In other words, it becomes easy to obtain good conductivity even when the amount of carbon material contained is kept low. Thus, by keeping low the amount of the carbon material contained, it becomes easy to increase strength of the heat-generating cement body. Therefore, with this invention, it is possible to increase strength while maintaining good conductivity.

Next, the testing that was performed to confirm the effect of the invention will be explained. First, as a premise to this testing, it is known that when using a heat-generating tile comprising a heat-generating cement body as a sidewalk tile with snow-removal function, it is preferable that the heat-generating cement body be heated using about 20 to 400 W. Also, using the relational expression (Heating Power) W=(Voltage) V²/(Resistance) R, it is known that in order to heat the heat-generating cement body with 20 W or greater by applying a voltage of 100 V, it is necessary to lower the resistance value of the heat-generating cement body to 533 Ω or less. Also, in order to heat the heat-generating cement body with 40 W or greater by applying a voltage of 100 V, it is necessary to lower the resistance value of the heat-generating cement body to 250 Ω or less. In this way, using the heat-generating cement body applied with a specified voltage, it is known that in order to obtain the desired heating power or more, it is effective to keep the resistance value of the heat-generating cement body low. However, when the amount of carbon material contained is increased in order to lower the resistance value, it becomes difficult to sufficiently maintain the strength of the heat-generating cement body. For example, when the amount of carbon material contained exceeds 10%, the strength of the heat-generating cement body is insufficient.

On the other hand, when performing testing using a heat-generating cement body having the same construction as that of this invention, it was possible to make the resistance value of the heat-generating cement body 533 Ω even when the amount of carbon material contained in the cement was sufficiently low at approximately 1.3 weight %, and it was possible to obtain a heating power of 20 W when a 100 V voltage was applied. Moreover, it was possible to make the resistance value of the heat-generating cement 250 Ω even when the amount of carbon material contained in the cement body was sufficiently low at approximately 1.8 weight %, and it was possible to obtain a heating power of 40 W when a 100 V voltage was applied. In this way, the heat-generating cement body of this invention was obtained by mixing particle-form or powder-form carbon material in un-hardened concrete or mortar at a specified ratio, and then pressing it with a high-pressure press to remove moisture, so it was possible to make the amount of carbon material contained low enough to obtain good conductivity, and it was possible to confirm that strength was increased while maintaining good conductivity.

On the other hand, different from this invention, in the case in which heat-generating cement is obtained by mixing particle-form or powder-form carbon material in un-hardened concrete or mortar, and simply letting it harden (without pressing it with a high-pressure press to remove moisture), when the ratio of the amount of carbon material contained is less than 10%, it was found that it is not possible make the resistance value of the heat-generating cement body sufficiently low, and it was not possible to maintain both strength and good conductivity.

Furthermore, in the case of this invention, by adjusting the ratio of the amount of carbon material contained in the heat-generating cement body to a specified value, it is possible to easily adjust the electrical resistance to a specified value, and to radiate far-infrared rays to the outside of the heat-generating cement body and heat-generating cement tile (it becomes easy to increase the intensity of radiation). As a result, when using the heat-generating cement body and heat-generating cement tile of this invention as a sidewalk tile in regions with heavy snowfall, it is possible to melt snow that accumulates on top of the sidewalk tile and prevent freezing of the top of the sidewalk tile. Moreover, by being easy to radiate far-infrared rays to the outside, it is possible to efficiently melt not only the snow on the bottom but all the way to the snow on top, and energy efficiency is good. The reason for this is that a self-heating action occurs due to vibration of water molecules, thus making it easy for all of the snow to melt. Also, the case of this invention differs from the case of heating concrete by simply installing Nichrome wire in the concrete, in that it is possible to sufficiently heat the entire heat-generating cement body with a low voltage, and thus it is possible to shorten the amount of time required to raise the temperature of the heat-generating cement body to a desired temperature (heat-up time). Therefore, it was possible to keep the amount of power consumed sufficiently low, or about ⅓ that of case in which nichrome wire is simply installed in the concrete.

On the other hand, in aforementioned patent document 3, a heat-generating cement body is disclosed in which cement, coarse graphite particles and short carbon fiber are the main materials. However, in the case of the construction disclosed in patent document 3, water is mixed with the main materials and then simply poured into a form, and differing from the case of this invention, the cement is not pressed with a high-pressure press to remove moisture. Therefore, it becomes difficult to uniformly distribute the graphite in the heat-generating cement body, and thus the distribution density becomes low. Also, since expensive short carbon fiber is required, it causes the cost to become high. On the other hand, in the case of this invention, these kinds of problems do not occur.

Moreover, with the method of manufacturing the heat-generating cement body of this invention, it is possible to embed a pair of electrodes inside the heat-generating cement body, and together with making it possible to more easily handle the heat-generating cement body, this makes it possible to effectively prevent separation of the heat-generating cement body and the pair of electrodes during use.

Also, with the method of manufacturing the heat-generating tile of this invention, it is possible to obtain a heat-generating cement body that is covered on all outer surfaces by insulation comprising insulating resin or plastic. Therefore, it becomes possible to more easily perform stable heating of the heat-generating cement body with the desired resistance value and desired amount of heating power regardless of the electrical resistance of concrete or mortar that comes in contact with the heat-generating cement body. Moreover, it become easy to prevent electric leakage, and it is possible to more effectively maintain safety. Furthermore, it is possible to embed the heat-generating cement body in the heat-generating cement tile, with all of the surfaces of the heat-generating cement body being covered. Therefore, together with making it easier to handle the heat-generating cement tile, it is possible to more effectively prevent separation of the heat-generating cement from the heat-generating cement tile during use, and it is possible to stably heat the heat-generating cement tile. Moreover, it is possible for the portion inside the heat-generating cement tile that contains carbon material to be just the heat-generating cement body, and the ratio of the amount of carbon material contained in the heat-generating cement tile can be kept low. Therefore, it is possible to reduce cost.

### BRIEF DESCRIPTION OF THE DRAWINGS

FIG. 1 is a drawing showing a heat-generating concrete body, which is the heat-generating cement body of a first embodiment of this invention.

FIG. 2 is a cross-sectional drawing of the section A-A in FIG. 1.

FIG. 3 is a drawing showing a sidewalk tile with a snow-removal function, which is the heat-generating cement tile of a first embodiment of the invention.

FIG. 4 is a cross-sectional drawing of the section B-B in FIG. 3.

FIGS. 5A to 5D are cross-sectional drawings showing the process steps for manufacturing the sidewalk tile with snow-removal function from the heat-generating concrete body of the first embodiment of the invention.

FIGS. 6A, 6B and 6C show the sidewalk tile with snow-removal function, which is the heat-generating cement tile of a second embodiment of the invention, where FIG. 6A is a view as seen from the front, and FIG. 6B and FIG. 6C are views as seen from the sides of FIG. 6A.

FIG. 7 is a cross-sectional drawing of the section C-O-O-C in FIG. 6A.

FIG. 8 is a drawing showing the state of adding water to and mixing the un-hardened concrete and graphite when making heat-generating mortar body, which is the heat-generating cement body, according to the manufacturing method of the second embodiment of the invention.

FIGS. 9A, 9B and 9C are cross-sectional drawings showing the process steps when manufacturing the heat-generating mortar body according to the second embodiment of the invention.

FIG. 10 is a drawing showing a partial view as seen from the top of FIG. 9A.

FIG. 11 is a drawing showing the view as seen from the bottom of FIG. 10.

FIG. 12 is a partial perspective drawing of the state shown in FIG. 10.

FIGS. 13A, 13B and 13C are drawings showing the process steps for manufacturing a sidewalk tile with snow-removal function from heat-generating mortar according to the second embodiment of the invention, and corresponds to FIG. 7 that has been turned up side down.

FIG. 14 is a schematic drawing showing a plurality of sidewalk tiles with snow-removal function that have been laid out.

### DESCRIPTION OF THE PREFERRED EMBODIMENTS

When embodying the invention described above, it is preferred that the heat-generating cement body be formed entirely into a tile shape.

With this preferred constriction, the work of manufacturing a tile shaped heat-generating cement tile becomes easy, and arrangement for placing electrodes on both sides can be performed easily.

It is even more preferable that the outer surfaces of the heat-generating cement body be covered with insulation.

With this more preferable construction, stable heating of this heat-generating cement body with a desired resistance value and desired heating power can be performed easily regardless of the electrical resistance of objects that are in contact with the heat-conducting cement body.

Moreover, it is even more preferable that the electrodes be embedded inside the heat-generating cement body.

With this even more preferable construction, different from the case in which the electrodes are placed on the surface of the heat-generating cement body, it is possible to prevent the problem of the electrodes peeling from the surface, and it is possible to increase the mounting strength of the electrodes. Also, it is not necessary to perform the troublesome work of adhering the electrodes to the surfaces on both sides after performing the process of applying pressure with a high-pressure press to remove moisture from the un-hardened concrete or mortar that contains particle-form or powder-form carbon material, and thus it is possible to reduce the number of work processes. Also, stable distribution of conductivity inside the cement body (stabilization of the distribution of electric current) is possible.

Furthermore, it is preferred, when manufacturing the heat-generating cement body such that it is entirely formed into a tile shape, that together with placing a pair of electrodes on the inside of the form in the areas near both ends such that they are parallel with each other, particle-form or powder-form carbon material be mixed into un-hardened concrete or mortar at a specified ratio and mixed with water, then poured into the form and pressed with a high-pressure press to remove the moisture and form the heat-generating cement body into a complete tile shape.

Also, it is preferred, when manufacturing heat-generating cement body whose outside surfaces are covered with insulation, that together with placing a pair of electrodes on the inside of the form in the areas near both ends such that they are parallel with each other, particle-form or powder-form carbon material be mixed into un-hardened concrete or mortar at a specified ratio and mixed with water, then poured into the form and pressed with a high-pressure press to remove the moisture and form the heat-generating cement. Also, a heat-generating cement body, whose outer surfaces are covered with insulation, is obtained by placing the heat-generating cement body, with electric wires connected to both end sections of each of the electrodes formed in the heat-generating cement body, into a concave section that is formed on the top surface of a base such that there is space between the underneath surface and outer surfaces of this heat-generating cement body and the bottom surface and inner surfaces of this concave section, and such that the top surface of the heat-generating cement body drops further downward than the edges on the top surface of the base on the opening end of this concave section, and then pouring melted insulating resin or plastic inside this concave section and letting this insulating resin or plastic harden.

With this preferred construction, in addition to the effect obtained by the construction of the invention described above, it is possible to obtain a heat-generating cement body whose outer surfaces are all covered by insulation comprising insulating resin or plastic. Therefore, stable heating of this heat-generating cement body with a desired resistance value and desired heating power can be performed more easily regardless of the electrical resistance of objects that are in contact with the heat-conducting cement body. Moreover, it is possible to more easily prevent current leakage, and to more effectively maintain safety.

### Embodiment 1

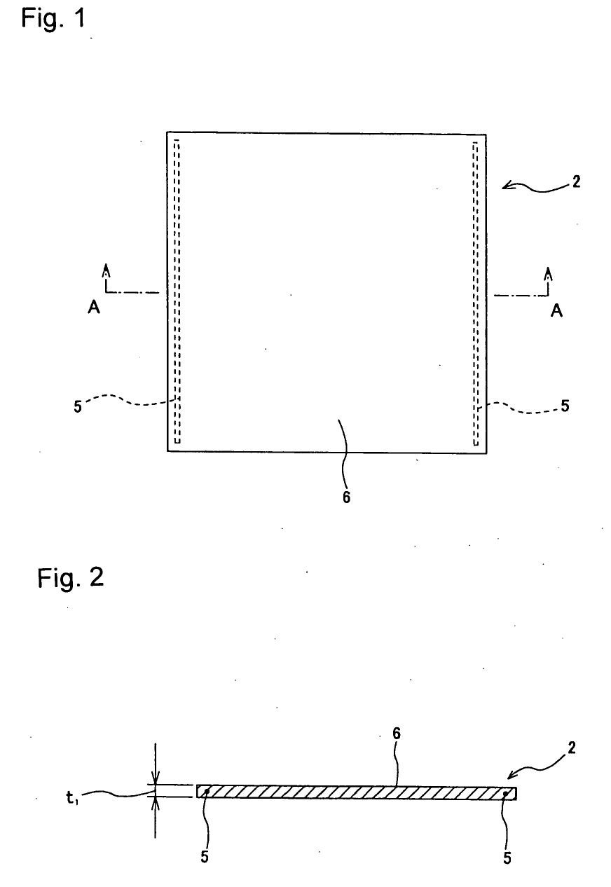

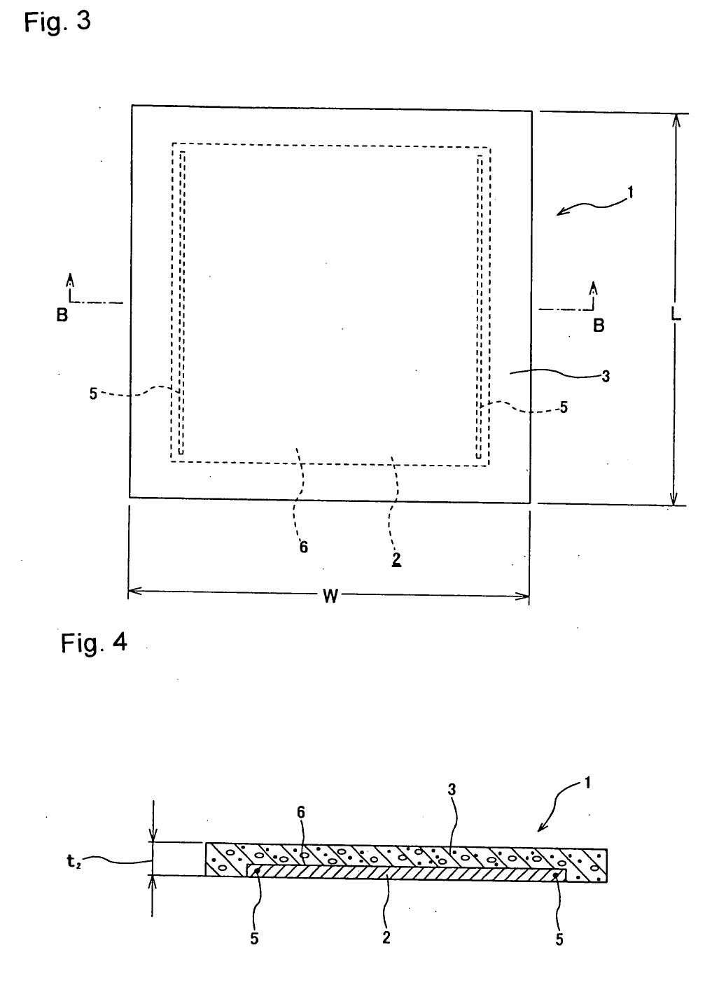

FIGS. 1 to 5 show a first embodiment of the invention. This embodiment is a heat-generating cement tile, where a sidewalk tile 1 with a snow-removal function is formed completely into a tile shape by combining a heat-generating concrete body 2, which is a heat-generating cement body that has been formed completely into a tile shape, with separate concrete 3. Of these, the heat-generating concrete body 2, as shown in detail in FIGS. 1 and 2, is a concrete body that is obtained by mixing carbon material such as particle-form or powder-form graphite to un-hardened (fresh) concrete at a specified ratio of 5 to 10 weight % and then applying pressure to it with a high-pressure press at approximately 980 kN (=100 tf) to remove moisture and form it into a tile shape. The thickness t₁ of this heat-generating concrete body 2 is approximately 7 mm. Also, when manufacturing this heat-generating concrete body 2, water is added to the aforementioned carbon material and un-hardened concrete and they are mixed together uniformly with a mixer.

The pressure that is applied by the high-pressure press in order to obtain the aforementioned heat-generating concrete body 2 is not limited to 980 kN, for example, any pressure in the range greater than 490 kN (=50 tf) is possible. Also, for example, as a method of applying pressure to remove moisture in order to obtain the heat-generating concrete body 2, a dehydration cloth can be spread on top of the table of the high-pressure press, and with the heat-generating concrete body 2 placed on top of this dehydration cloth, pressure is applied by the pressure section of the high-pressure press from the top of the heat-generating concrete body 2. This dehydration cloth freely discharges the moisture and air inside the concrete by way of the portion of the cloth that is separated from the portion that is pressed between the bottom surface of the heat-generating concrete body 2 and the top surface of the table. Therefore, by using a high-pressure press to apply pressure and remove moisture from the materials of the heat-generating concrete body 2, it is possible to obtain the aforementioned heat-generating concrete body 2.

Furthermore, there is a pair of electrodes 5 that are embedded in both end sections in the width direction (left-right direction in FIGS. 1 to 5) of the heat-generating concrete body 2 such that they are parallel with each other. Each of these electrodes 5 is made of copper, carbon fiber or the like. Also, each of these electrodes 5 can be made by using silver paste on copper. Different from the example shown in the figures, it is also possible to place each of these electrodes 5 while being exposed to the outside on the edges of both sides in the width direction of the heat-generating concrete body 2, such that they are parallel to each other. Also, together with connecting conductors (not shown in the figures) to the end sections of the electrodes 5, each of these conductors leads to the outside of the heat-generating concrete body 2. Moreover, the outer surfaces of the heat-generating concrete body 2, in all areas except the leads from each of the conductors, are covered by an insulating layer (insulating film) 6 that is made from silicon rubber having a thickness of several μm. In the case of this embodiment, this insulating coating layer 6 corresponds to the insulation of this invention.

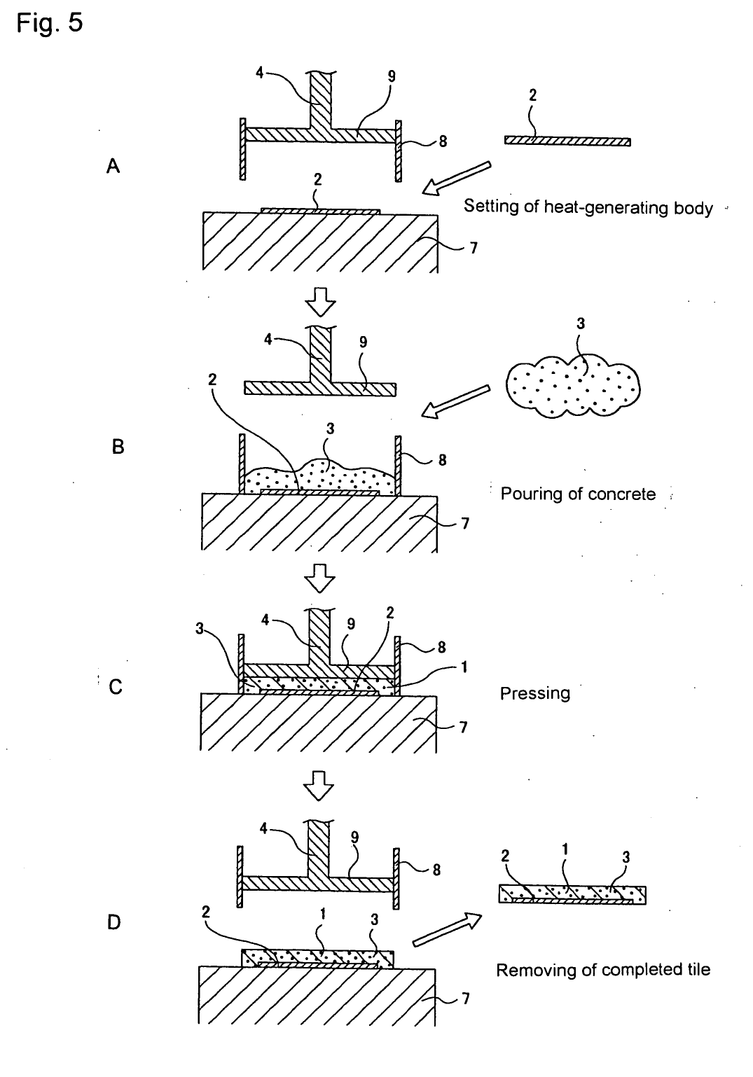

Also, by using a high-pressure press 4 to apply a pressure of about 980 kN (=100 tf) to this kind of heat-generating concrete body 2 of which one side (top side in FIGS. 4 and 5) and the circumference are covered with un-hardened concrete, the aforementioned sidewalk tile 1 with snow-removal function is formed into a single tile. In order to do this, this sidewalk tile 1 with snow-removal function can be manufactured as described below, for example. First, as shown in FIG. 5A, the aforementioned heat-generating concrete body 2 is placed on the top surface of the table of the high-pressure press 4. Next, as shown in FIG. 5B, a form 8 having a quadrangle-shaped cross-section is placed around this heat-generating concrete body 2, and un-hardened concrete 3 is then poured into the form 8 from the top of the form 8. This concrete 3 covers one side and circumference of the heat-generating concrete body 2. Next, as shown in FIG. 5C, the pressure section 9 of the high-pressure press 4 applies a pressure of about 980 kN from the top side of the concrete 3. Then, as shown in FIG. 5D, after raising the pressure section 9 and form 8, the completed sidewalk tile 1 with snow-removal function that is integrated with the aforementioned concrete 3 and formed into a tile shape is removed from the high-pressure press 4. The width W and length L of this sidewalk tile 1 with snow-removal function are both 240 mm for example, and the thickness t₂ is 10 to 100 mm. The size of the pressure applied by the high-pressure press 4 in order to obtain this sidewalk tile 1 with snow-removal function is not limited to 980 kN, and can be any pressure as long as it is possible to integrate the aforementioned heat-generating concrete body 2 with the concrete 3.

This kind of sidewalk tile 1 with snow-removal function is used by placing a plurality of tiles together on top of the ground that will become the bottom side of the sidewalk. Also, AC or DC current flows through each of the electrodes 5 from a power supply (not shown in the figures) that is connected to the electrodes 5 inside each of the sidewalk tiles 1 with snow-removal function by way of conductors. For example, a current having a 10 to 100 W output flows through each of the sidewalk tiles 1 with snow-removal function. According to testing by the inventors, it was found that by supplying a current for which it is possible to obtain this range of output, it is possible to obtain the desired amount of heating power. In other words, from the relationships that (Voltage) V=(Current) I×(Resistance) R, and (Power) W=(Voltage) V×(Current) I, the resistance value inside each of the sidewalk tiles 1 with snow-removal function is set to a specified value, and by supplying a specified amount of current, it is possible to obtain the desired amount of heating power. Also, by regulating the ratio of the carbon material inside the heat-generating concrete body 2, it is possible to easily adjust the resistance value inside each of the sidewalk tiles 1 with snow-removal function to a desired value. As a result, it is possible for the temperature of these sidewalk tiles 1 with snow-removal function to easily rise within the range 0 to 100° C. However, normally, is sufficiently possible to melt snow that has accumulated on top of each of the sidewalk tiles 1 with snow-removal function by raising the temperature of these sidewalk tiles 1 with snow-removal function to about 30° C. Therefore, taking energy conservation into consideration, it is preferred that the current flowing in the electrodes 5 and the resistance value inside the sidewalk tiles 1 with snow-removal function be regulated so that the temperature is about 30° C.

With the heat-generating cement body and heat-generating cement tile of this invention that are constructed and used as described above, the heat-generating concrete body 2 is constructed by using a high-pressure press to apply pressure to and remove moisture from un-hardened concrete containing carbon material, and form it into a specified shape. Therefore, together with sufficiently pressing out the moisture and air from the un-hardened concrete material, it is possible to increase the distribution density of the carbon material. Also, it is nearly possible to uniformly mix the carbon material inside the heat-generating concrete body 2. Therefore, it is difficult for contact between adjacent carbon material particles to be hindered, thus it is possible to easily and effectively bring adjacent carbon material particles into contact. Also, by adequately adjusting the ratio of the amount of carbon material contained inside the heat-generating concrete body 2 as described in this embodiment, the adjacent particle-form or powder-form carbon material is effectively brought into contact with each other, so it is possible to easily adjust the electrical resistance inside the heat-generating concrete body 2 to a specified value. As a result, by passing current through the inside using the electrodes 5 that are located on both sides of this heat-generating concrete body 2, it is possible to heat the heat-generating concrete body 2 and sidewalk tile 1 with snow-removal function to a desired temperature. Also, with this invention, it is possible to stably obtain this kind of construction.

Furthermore, in the case of this invention, by adjusting the ratio of the amount of carbon material contained inside the heat-generating concrete body 2 to a specified value, it is possible to easily adjust the electrical resistance to a specified value and to radiate far infrared rays to the outside of the heat-generating concrete body 2 and sidewalk tiles 1 with snow-removal function (it becomes possible to easily increase the radiation intensity). As a result, when using the sidewalk tiles 1 with snow-removal function as sidewalk tiles in regions with high amounts of snow fall, it is possible to melt snow that accumulates on the top of the sidewalk tiles and prevent freezing of the top of the sidewalk tiles. Also, since it is easy to radiate far infrared rays to the outside, it is possible to effectively melt snow not just on the bottom but snow all the way to the top as well, and energy efficiency is good.

Also, in this invention, the heat-generating concrete body 2 is formed completely into a tile shape, so the work of manufacturing tile-shaped sidewalk tiles 1 with snow-removal function becomes easy, and it is easy to place electrodes 5 on both sides. Moreover, since nearly all of the outer surfaces of the heat-generating concrete body 2 are covered with an insulating coating layer 6, it is possible to easily and stably heat this heat-generating concrete body 2 with a desired amount of heating power at a desired resistance value, regardless of the electrical resistance of another material such as other concrete 3 that comes in contact with the heat-generating concrete body 2.

Different from the case of this invention, and as mentioned above, simply adding a specified amount of carbon material to un-hardened concrete 3 and letting it harden into a tile shape without pressing it with a high-pressure press is feasible. However, in the case of this kind of construction, not only is it difficult to uniformly mix in the carbon material, the moisture and air that exist in the concrete material hinder contact among the carbon material. Therefore, it is difficult to adjust the resistance value of the concrete to a desired value and stably heat the concrete with a desired amount of heating power, and it becomes difficult to effectively generate far infrared radiation. On the other hand, the heat-generating cement body of this invention that is constructed as described above by pressing it with a high-pressure press to remove moisture is superior in that this kind of problem does not occur.

Also, in the case of the example shown in the figures, only the circumference and one side (top side in FIGS. 2, 4 and 5) of the heat-generating concrete body 2 are covered with concrete 3, however, the heat-generating concrete body 2 of this invention is not limited to this kind of construction, and it is also possible to cover all of the surfaces of the heat-generating concrete body 2, including the other side (bottom side in FIGS. 2, 4 and 5), with concrete 3.

In the embodiment described above, the case in which a heat-generating cement body is constructed by mixing in particle-form or powder-form carbon material in un-hardened concrete at a specified ratio, and then pressing it with a high-pressure press to remove moisture and form it into a specified shape was explained. However, the heat-generating cement body of this invention is not limited to this construction, and can also be constructed by mixing particle-form or powder-form carbon material into un-hardened mortar at a specified ratio, and then pressing it with a high-pressure press to remove moisture and form it into a specified shape. Moreover, the heat-generating cement body of this invention is also not limited to being formed by placing un-hardened concrete on at least one side of the heat-generating cement and then pressing it with a high-pressure press to form it into a tile shape, but can also be formed by placing un-hardened mortar on at least one side of the heat-generating cement body and then pressing it with a high-pressure press to form it into a tile shape.

Also, in the constriction of this embodiment, the heat-generating concrete body 2 can be manufactured by mixing carbon material such as particle-form or powder-form graphite into un-hardened concrete at a specified ratio of 5 weight % or less (preferably 2 weight % or less), and pressing it with a high-pressure press to remove the moisture and form it into a tile shape. With the construction of this invention, it is possible to obtain good conductivity even when containing carbon material at this kind of low ratio. Also, in this case, the strength of the heat-generating concrete body 2 can be easily increased.

### Embodiment 2

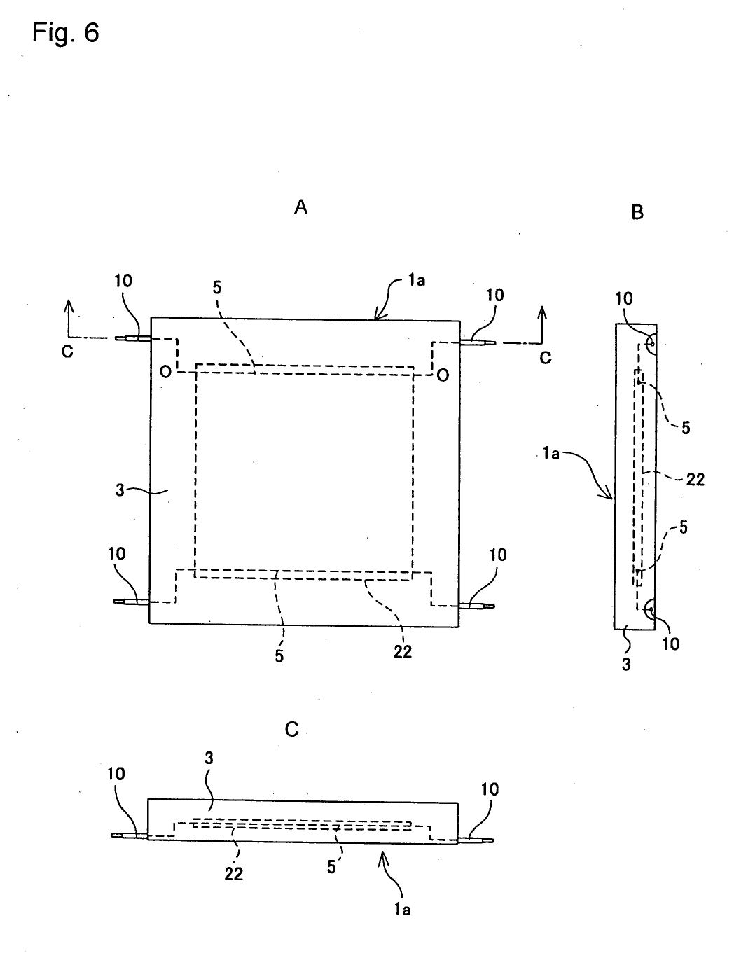

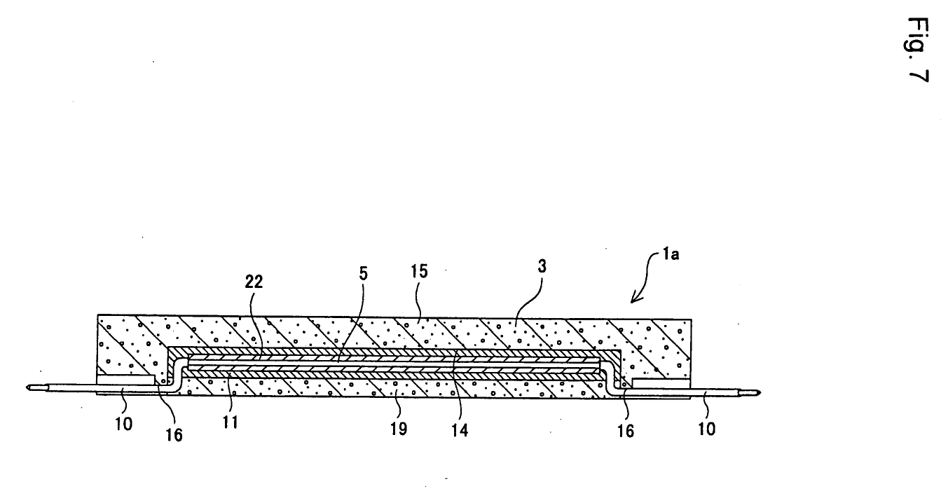

Next, FIGS. 6A, 6B and 6C show a second embodiment of the invention. As shown in FIGS. 6A, 6B and 6C and FIG. 7, the sidewalk tile 1a with snow-removal function, which is the heat-generating cement tile of this embodiment, is formed entirely into a tile shape by joining a heat-generating mortar body 22, which is a heat-generating cement body that is formed entirely into a tile shape, with other concrete 3. Of these, the heat-generating mortar body 22 is formed by mixing particle-form or powder-form carbon material such as graphite into un-hardened (fresh) mortar at a specified ratio less than 2 weight %, for example 1.3 to 1.8 weight %, and then pressing it with a high-pressure press at a pressure of 980 kN (=100 tf) or greater to remove moisture and form it into a tile shape. It is preferable that the applied pressure be 1470 kN (=150 tf) or greater, and even more preferable that it be 4900 kN (=500 tf) or greater. Also, all areas on the outer surfaces of this heat-generating mortar body 22, except for the areas where the leads connected to the electric wiring 10 for supplying power (explained later) are located, are covered with insulation 11 made of insulating resin or plastic such as epoxy resin or polyurethane plastic. Moreover, a pair of electrodes 5 is embedded along both end sections in the width direction of the heat-generating mortar body 22 (vertical direction in FIGS. 6A, 6B and 7, and front to back direction in FIG. 6C) such that they are parallel with each other.

Also, the aforementioned heat-generating mortar body 22 embedded inside other concrete 3 is joined with the other concrete 3 to form a sidewalk tile 1a with snow-removal function. Power-supply wires 10 lead into both side surfaces in the lengthwise direction of this sidewalk tile 1a with snow-removal function (left-right direction in FIGS. 6A, 6C, and front-back direction in FIG. 6B) and into both end sections in the width direction (vertical direction in FIGS. 6A, 6B, and front-back direction in FIG. 6C) of the sidewalk tile la with snow-removal function, and one end of each of these power-supply wires 10 is connected to the both ends of the electrodes 5 that are embedded inside the heat-generating mortar body 22.

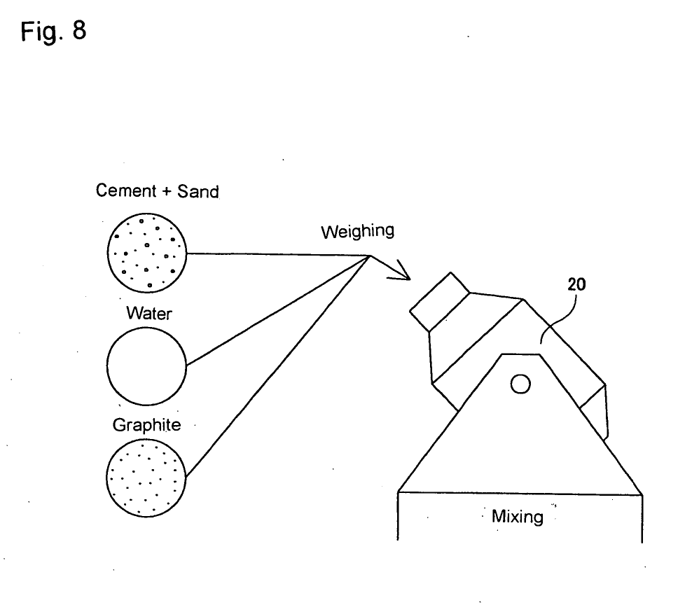

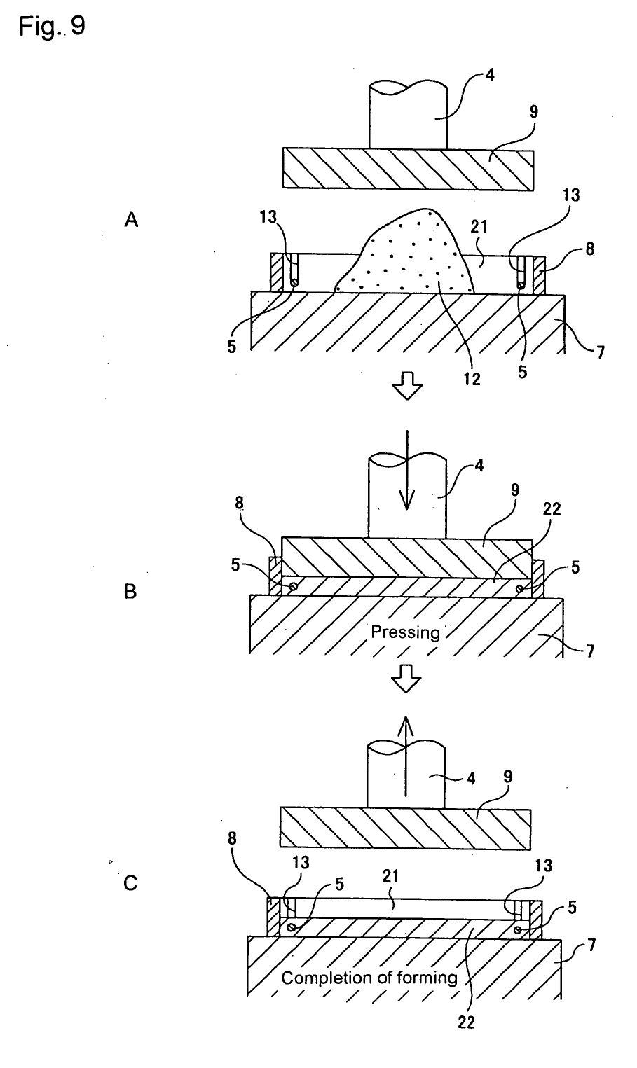

The sidewalk tile 1a with snow-removal function described above is made as follows. First, as shown in FIG. 8, in order to make the heat-generating mortar body 22, particle-form or powder-form carbon material such as graphite is mixed into the cement and sand of the un-hardened (fresh) mortar at a specified ratio of 2 weight % or less, for example 1.3 to 1.8 weight %, and uniformly mixed with water in a mixer 20, such as an Omni mixer, to obtain the raw heat-generating mortar 12 (see FIGS. 9 to 11). In this case, the size of the graphite particles is, for example, 30 to 50 nm, and preferably about 38 nm.

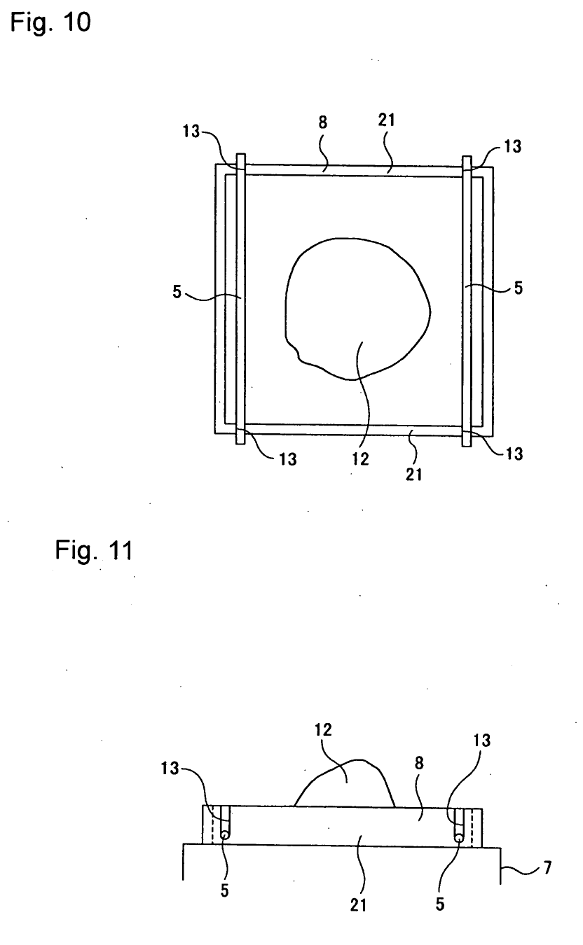

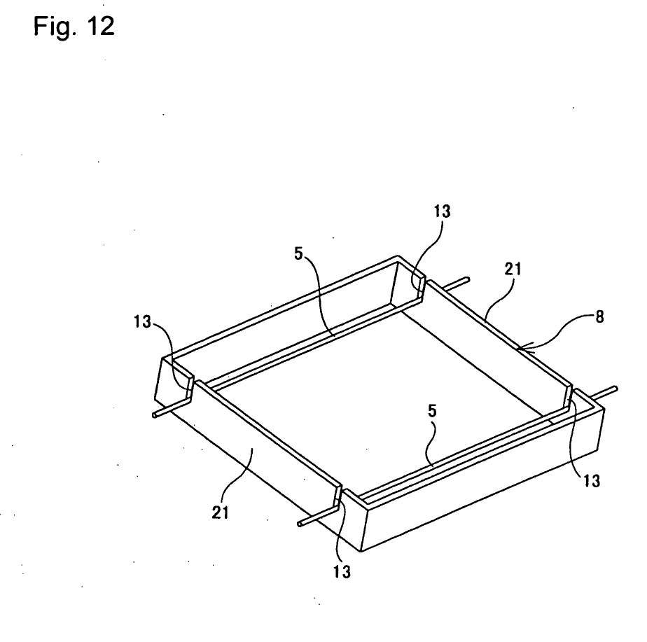

Next, by applying the pressure described above using a high-pressure press to remove moisture, the raw heat-generating mortar 12 is formed into a tile shape having specified dimensions and having a pair of electrodes 5 embedded inside. In order to do this, first, as shown in FIG. 9A, and FIGS. 10 to 12, a rectangular form 8 is placed on top of a dehydration cloth (not shown in the figure) that is spread over the top surface of the table 7 of the high-pressure press 4. Also, a pair of electrodes 5 is extended in the lengthwise direction (front-back direction in FIGS. 9, 11, and vertical direction in FIG. 10) in two locations on the top end surface of this form 8 such that they are separated from each other in the width direction (left-right direction in FIGS. 9 to 11). Also, both end sections of each of the electrodes 5 are fastened to pairs of slot sections 13 that are formed on the top end surfaces of side sections 21 that are located on both end sections in the lengthwise direction of the form 8. In this state, these electrodes 5 are arranged such that they are parallel with each other, and both of the end sections of these electrodes 5 protrude from the outside surface of each of the side sections 21 about 20 mm.

Next, a specified amount of the raw heat-generating mortar 12 is poured into the form 8. As shown in FIG. 9B, this raw heat-generating mortar 12 is then pressed by the pressure section 9 of the high-pressure press 4 at a pressure of 4900 kN. By doing this, the moisture contained inside the raw heat-generating mortar 12 is discharged to the outside of the form 8 by way of the dehydration cloth, to obtain a tile shaped, hardened heat-generating mortar body 22. Also, as shown in FIG. 9C, with the pressure section 9 of the high-pressure press 4 raised, the end sections of the electrodes 5 are removed from the slot sections 13, and the heat-generating mortar body 22 is removed from the form 8.

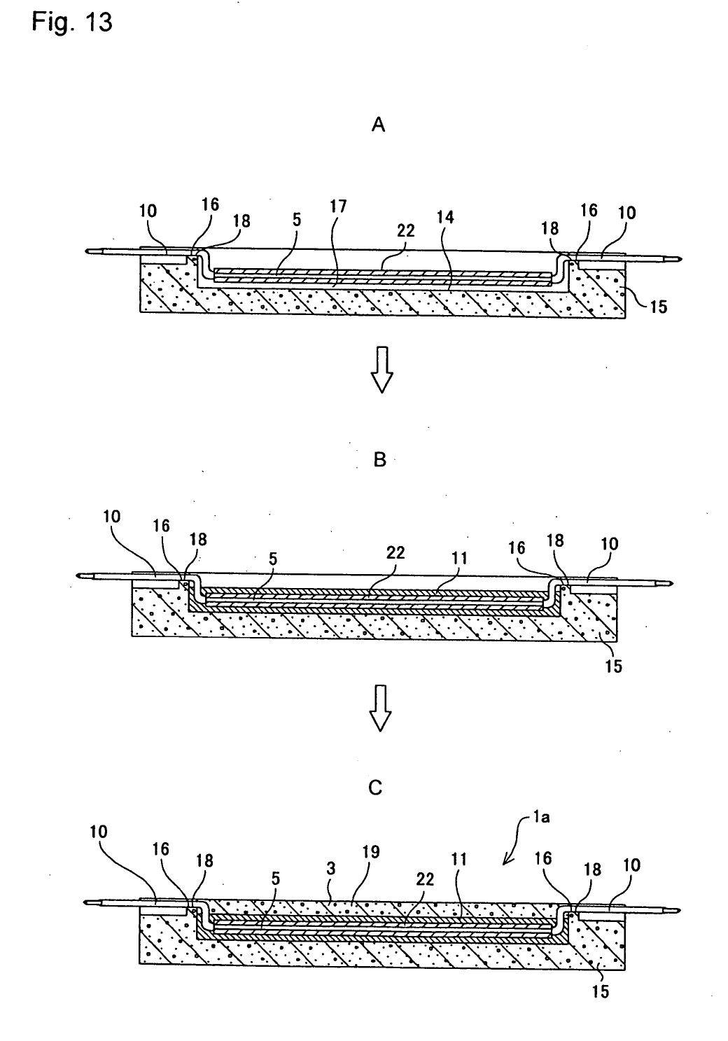

Next, the outer surfaces of the heat-generating mortar body 22 that was removed in this way is covered by insulation 11 and joined together with other concrete 3. In order to do this, first, as shown in FIG. 13A, one end of power-supply wires 10 are connected to both of the ends of the electrodes 5 of the heat-generating mortar body 22. Next, the heat-generating mortar body 22 is placed inside a concrete tile-shaped member 15 that is formed such that it has a rectangular-shaped concave section formed in the middle section of the top surface. Pairs of grooves 16 having a depth that is greater than the diameter of the power-supply wires 10 are formed in the surface on both end sections in the lengthwise direction (left-right direction in FIG. 13) of the tile-shaped member 15. Both ends of these grooves 16 run from the concave section 14 that is formed inside the tile-shaped member 15 to the outer surface of the tile-shaped member 15. The middle sections of the power-supply wires 10 are fastened inside these grooves 16, and the heat-generating mortar body 22 is placed inside the concave section 14. In this state, there are spaces 17 formed between the underneath surface and surfaces around the circumference of the heat-generating mortar body 22, and the bottom surface and inner surfaces of the concave section 14. Therefore, the underneath surface and surfaces around the circumference of the heat-generating mortar body 22 are separated from (not touching) the inner surfaces of the concave section 14. Also, the top surface of the heat-generating mortar body 22 is placed such that it is below the bottom surface 18 of the grooves 16 that are located on the edges on the opening of the concave section 14 on the surface of the top end of the tile-shaped member 15.

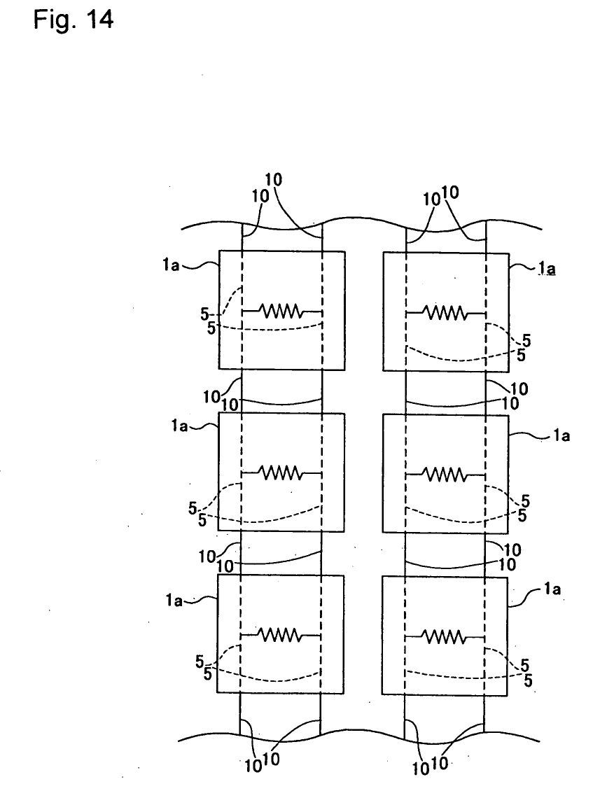

Next, in this state, as shown in FIG. 13B, melted insulating resin or plastic (epoxy resin, polyurethane plastic, etc.) is poured into the concave section 14 so that the heat-generating mortar body 22 is completely embedded inside it, and by letting this insulating resin or plastic harden, all of the surfaces of the heat-generating mortar body 22 are covered by insulation 11. After this, as shown in FIG. 13C, un-hardened concrete is poured into the concave section 14 on top of the heat-generating mortar body 22, and by letting this poured concrete harden, a lid-shaped member 19 is formed. The lid-shaped member 19 fits inside the concave section 14 of the tile-shaped member 15, and together with the tile-shaped member 15, forms the aforementioned other concrete 3. As a result, the completed sidewalk tile la with snow-removal function is obtained. As shown in FIG. 14, when using this kind of sidewalk tile 1a with snow-removal function, a plurality of sidewalk tiles 1a with snow-removal function are arranged on the ground such that for each pair of sidewalk tile 1a ith snow-removal function, the electrodes 5 on the same side in the width direction are connected to each other in series. Each of the sidewalk tiles 1 a with snow-removal function are heated by supplying AC or DC current to these electrodes 5.

With the method for manufacturing the heat-generating cement of this embodiment that is constructed as described above, it is possible to obtain a heat-generating mortar body 22 that is covered on all surfaces by insulation 11 that is made from insulating resin or plastic. Therefore, stable heating of this heat-generating mortar body 22 with a desired resistance value and desired amount of heating power can be performed more easily regardless of the electrical resistance of the other concrete 3 that comes in contact with the heat-conducting mortar body 22. Moreover, it is possible to more easily prevent current leakage, and to more effectively maintain safety.

Moreover, in the case of this embodiment, it is possible to embed the heat-generating mortar body 22 inside the sidewalk tile 1a with snow-removal function with all of the surfaces of the heat-generating mortar body 22 covered. Therefore, together with being able to simplify the handling of the sidewalk tile la with snow-removal function, it is possible to more effectively prevent separation of the heat-generating mortar 22 from the sidewalk tile 1a with snow-removal function during use, and to stably heat the sidewalk tile 1a with snow-removal function. Furthermore, it is possible to have only the heat-generating mortar body 22 be the portion inside the sidewalk tile 1a with snow-removal function that contains graphite, so it is possible to keep the ratio of the amount of graphite contained inside the sidewalk tile 1a with snow-removal function low. Therefore, it is possible to reduce costs.

The other construction and functions are the same as in the first embodiment described above, so any redundant explanation will be omitted here.

Also, using the sidewalk tile la with snow-removal function (implemented product) having the construction of this embodiment, 500 V voltage was applied to find the electrical resistance (resistance value) of the insulation 11 from the voltage difference between the electrodes 5 located inside and the surface of the sidewalk tile 1a with snow-removal function by the water method, and it was found to be 50 M Ω or more, which is sufficiently high. Moreover, in the case of this embodiment, melted insulating resin or plastic is poured into the concave section 14 that is formed into the concrete tile-shaped member 15 such that the heat-generating mortar body 22 is completely embedded in it; and by letting this insulating resin or plastic harden, all of the surfaces of the heat-generating mortar body 22 are covered with insulation 11. Therefore, it is possible to keep the occurrence of the problem of early deterioration of the heat-generating mortar body 22 due to the atmosphere or outside pressure to a minimum. Moreover, in the case of this embodiment, since the electrical resistance of the insulation 11 is sufficiently high, it is possible to safely maintain good performance of the sidewalk tile 1a with snow-removal function even in use where a high voltage of 220V is used.

When manufacturing the heat-generating mortar body 22, the method of placing the pair of electrodes 5 in the sections near both ends on the inside of the form 8 such that they are parallel with each other is not limited to the case of the embodiment described above of fastening both end sections of the electrodes 5 in slots 13 that are formed in the end surfaces of the form 8. For example, by constructing the form using elements that divide it into an upper and lower section, it is possible to arrange the electrodes inside this form such that they are parallel with each other by fastening both ends of the electrodes 5 in slots that are formed in the end surfaces of at least one of these elements that face each other.

Different than in either of the embodiments described above, by drying the heat-generating cement body sufficiently with a dryer, it is possible to obtain a dry heat-generating cement body from which the moisture inside has been completely removed. In the case of a heat-generating cement body that has been completely dried in this way, different than the case of manufacturing a heat-generating cement body by simply pressing the raw heat-generating cement material to remove the moisture, it is possible to more effectively prevent the leakage of current during use due to moisture inside the cement. Moreover, it is preferred that the outer surfaces of the dried heat-generating cement body be insulated by insulation such as film or a layer of insulation coating. With this construction, it is possible to more easily heat the heat-generating cement body with a desired amount of heating power.

### INDUSTRIAL APPLICABILITY

The heat-generating cement body and heat-generating cement tile of this invention are not limited to use as a sidewalk tile as described above, for example, it could also be used as construction material for walls or floors, or as roofing material such as roof tiles. For example, in the case of use as roofing material, it is possible to effectively melt (remove) snow that accumulates on top of the roofing material. In the case of use as construction material for walls or floors, it serves for indoors heating. Also, when using the heat-generating cement body of this invention as a part of the roofing material, it is possible to cover the outer surfaces of the heat-generating cement body with insulation and apply it to the rear surface of the roofing material (roofing tile). In that case, the insulation is manufactured by letting melted insulating resin or plastic harden the same as in the case of the second embodiment described above. Moreover, it is possible to maintain the electrical resistance of the insulation at 2 M Ω when a voltage of 250 V is applied, and by keeping the power-supply voltage 24 V or less, it is possible to even more effectively maintain safety. Furthermore, with the heat-generating cement body and heat-generating cement tile of this invention, by properly adjusting the ratio of the amount of carbon material contained in the cement body, it becomes possible to easily heat the cement body with a desired amount of heating power within a wide range of 5 to 300 W, and to set the operating power-supply voltage to a desired value within a wide range of 12 to 240 V.

1-11. (canceled)

12. A heat-generating cement body, comprising:
a cement body having a specified shape, which cement body contains granular or powder-like carbon material, the carbon material being initially contained in un-hardened concrete or mortar at a specified ratio, and then pressed by a high-pressure press to remove moisture therein and to form the specified shape; and
electrodes arranged in the cement body at both sides of the cement body, the electrodes being capable of passing electric current through the inside of the cement body.

13. The heat-generating cement body of claim 12 that is formed entirely into a tile shape.

14. The heat-generating cement body of claim 12, wherein the cement body is covered on an outer surface with insulation.

15. The heat-generating cement body of claim 13, wherein the cement body is covered on an outer surface with insulation.

16. The heat-generating cement body of claim 14, wherein the electrodes are embedded inside the cement body.

17. A heat-generating cement body, comprising:
concrete or mortar in which granular or powder-like carbon material is distributed uniformly at a ratio of 1.3% weight to 10% weight; and
wherein electrodes are embedded inside in order that electric current may flow freely in the concrete or mortar.

18. A heat-generating cement tile comprising the heat-generating cement body of claim 12, wherein un-hardened concrete or mortar on at least one side of said heat-generating cement body is pressed by a high-pressure press to integrate the heat-generating cement body with the concrete or mortar into a tile shape.

19. A heat-generating cement tile comprising the heat-generating cement body of claim 17, wherein un-hardened concrete or mortar on at least one side of said heat-generating cement body is pressed by a high-pressure press to integrate the heat-generating cement body with the concrete or mortar into a tile shape.

20. A heat-generating cement tile comprising the heat-generating cement body of claim 12, wherein the cement body is embedded inside concrete or mortar.

21. A heat-generating cement tile comprising the heat-generating cement body of claim 17, wherein the cement body is embedded inside concrete or mortar.

22. A method for manufacturing a heat-generating cement body, the method comprising the acts of:
arranging a pair of electrodes parallel with each other inside a form in sections near both ends of the form;
mixing granular or powder-like carbon material into un-hardened concrete or mortar at a specified ratio and then mixing with water and pouring the mixture into the form; and
pressing the poured concrete or mortar with a high-pressure press to remove moisture.

23. A method for manufacturing a heat-generating cement body, the method comprising the acts of:
arranging a pair of electrodes parallel with each other inside a form in sections near both ends of the form;
mixing granular or powder-like carbon material into un-hardened concrete or mortar at a specified ratio and then mixing with water and pouring the mixture into the form;
pressing the poured concrete or mortar with a high-pressure press to remove moisture and to form the heat-generating cement body entirely into a tile shape.

24. A method for manufacturing a heat-generating cement body, the method comprising the acts of:
arranging a pair of electrodes parallel with each other inside a form in sections near both ends of the form;
mixing granular or powder-like carbon material into un-hardened concrete or mortar at a specified ratio and then mixing with water and pouring the mixture into the form;
pressing the poured concrete or mortar with a high-pressure press to remove moisture and form the heat-generating cement body;
connecting electric wires to both end sections of each of the electrodes of the heat-generating cement body and placing the heat-generating cement body inside a concave section that is formed on a top surface of a base so that there is space between the underneath surface and surfaces around the circumference of the heat-generating cement body and the bottom surface and inner surfaces of the concave section, such that the top surface of the heat-generating cement is dropped below the edges around the opening of the concave section on the top surface of the base; and
pouring melted insulating resin or plastic into the concave section and letting it harden, whereby a heat-generating cement body whose outer surfaces are covered with insulation is obtained.

25. A method for manufacturing a heat-generating cement tile, the method comprising the acts of:
arranging a pair of electrodes parallel with each other inside a form in sections near both ends of the form;
mixing granular or powder-like carbon material into un-hardened concrete or mortar at a specified ratio and then mixing with water and pouring the mixture into the form;
pressing the poured concrete or mortar with a high-pressure press to remove moisture and form the heat-generating cement body;
connecting electric wires to both end sections of each of the electrodes of the heat-generating cement and placing the heat-generating cement body inside a concave section that is formed on a top surface of a concrete or mortar tile-shaped member so that there is space between the underneath surface and surfaces around the circumference of the heat-generating cement body and the bottom surface and inner surfaces of the concave section, such that the top surface of the heat-generating cement body is dropped below the edges around the opening of the concave section on the top surface of the tile-shaped member; and
after pouring melted insulating resin or plastic into the concave section and letting it harden, pouring un-hardened concrete or mortar on top of the heat-generating cement inside the concave section, wherein the concrete or mortar is allowed to harden so as to be integrated with the tile-shaped member and the heat-generating cement body.
